(19) United States
(12) Patent Application Publication
(10) Pub. No.: US 2025/0084631 A1
(43) Pub. Date: Mar. 13, 2025

(54) TOOL CARRIER FOR SEWER INSPECTION AND/OR MAINTENANCE SYSTEM

(71) Applicant: iPEK International GmbH, Sulzberg (DE)

(72) Inventors: Vreni Tolsdorf, Kempten (DE); Johannes Wiese, Immenstadt (DE); Simon Schweizer, Kempten (DE); Anton Krämer, Kempten (DE)

(21) Appl. No.: 18/883,988

(22) Filed: Sep. 12, 2024

(30) Foreign Application Priority Data
Sep. 13, 2023 (DE) 10 2023 124 738.7

(51) Int. Cl. E03F 7/12; B25J 18/00

(52) U.S. Cl. CPC E03F 7/12; B25J 18/00

(57) ABSTRACT

A tool carrier for sewer inspection and/or maintenance systems is provided for mounting different devices on a carrier system, in particular a trolley or push rod of the sewer inspection and/or maintenance system, wherein the tool carrier
is or can be arranged on the carrier system,
has an adapter designed for removably attaching the devices to the tool carrier, and
has a first interface device that corresponds to a second interface device of the device, the first interface device having a number of first ports, wherein at least one port of the first ports can be coupled to at least one port of a number of second ports of the second interface device, whereby the devices can be interchangeably attached to the tool carrier.

There is further provided a sewer inspection and/or maintenance system comprising a carrier system with a tool carrier according to the invention.

### CROSS-REFERENCE TO RELATED APPLICATIONS

This application claims priority to German Patent Application Serial No. DE 10 2023 124 738.7, filed Sep. 13, 2023, the entire disclosure of which is hereby incorporated herein by reference in its entirety.

### FIELD OF THE INVENTION

The invention relates to a tool carrier for sewer inspection and/or maintenance systems for mounting devices on a carrier system of the sewer inspection and/or maintenance system, wherein the carrier system particularly comprises a crawler or a push rod.

### BACKGROUND OF THE INVENTION

Sewer inspection systems or sewer maintenance systems are known from the prior art, for example from EP 2 689 227 A1. FIG. 1 shows the system known from EP 2 689 227 A1. The system consists of a crawler F and a lifter H arranged on it. An inspection camera IK is arranged at the free end of the lifter H. The inspection camera has its own specific interface. The free end of the lifter H has a specific interface corresponding to the interface of the inspection camera. The inspection camera can thus be removed from the lifter and reattached.

It is disadvantageous here that the interface between the inspection camera and the lifter is specific to the inspection camera. This means that only inspection cameras with exactly one such an interface can be attached to the lifter. If a camera has a different interface, it is common to use a correspondingly adapted lifter. That is, different lifters are provided for cameras with different interfaces, which lifters may need to be replaced.

Another disadvantage is that to change the camera, the system has to be taken out of the sewer, and then can be put back into the sewer after changing the camera and the lifter. Long setup times can lead to a considerable loss of time during a sewer inspection.

### OBJECT OF THE INVENTION

An object of the present invention is therefore to provide solutions that allow various devices to be mounted on a sewer inspection and/or maintenance system without having to replace other components or parts of the sewer inspection and/or maintenance system, thereby enabling more efficient maintenance and/or inspection of a sewer.

### SUMMARY OF THE INVENTION

This object is achieved by means of a tool carrier for sewer inspection and/or maintenance systems for mounting different devices on a carrier system of the sewer inspection and/or maintenance system, and a correspondingly adapted sewer inspection and/or maintenance system according to the independent claims. Advantageous embodiments of the invention are set forth in the specific dependent claims.

A tool carrier for sewer inspection and/or maintenance systems is provided for mounting different devices on a carrier system, in particular a crawler or push rod of the sewer inspection and/or maintenance system, wherein the tool carrier
is or can be arranged on the carrier system,
has an adapter designed for removably attaching the devices to the tool carrier,
has a first interface device that corresponds to a second interface device of the device, wherein the first interface device has a number of first ports, wherein at least one port of the first ports can be coupled to at least one port of a number of second ports of the second interface device, whereby the devices can be attached to the tool carrier in an interchangeable manner.

The first ports and the second ports can comprise
at least one port for data transmission, and/or
at least one port for transmitting electrical energy, and/or
at least one hydraulic port, and/or
at least one pneumatic port

A sewer inspection and/or maintenance system according to the invention comprises a carrier system, in particular a crawler or push rod, and a number of different devices, wherein
a tool carrier is arranged on the carrier system,
the tool carrier has a first adapter for removably arranging a device of the number of different devices on the tool carrier,
the tool carrier has a first interface device and the number of different devices each have a second interface device, wherein the first interface device corresponds to the second interface device,
the first interface device has a number of first ports and the second interface device has a number of second ports, wherein at least one port of the first ports can be coupled to at least one port of the second ports when a device of the number of different devices is mounted on the tool carrier.

Because at least one port of the first ports can be coupled to at least one port of the second ports, it is not necessary for the first interface device and the second interface device to have the same number of ports, as long as a port of the first interface device can be coupled to a port of the second interface device. This makes it possible to mount different devices on the tool carrier in an advantageous manner, even if they are completely different device categories.

It is advantageous if the first ports and the second ports comprise
at least one port for data transmission, and/or
at least one port for transmitting electrical energy, and/or
at least one hydraulic port, and/or
at least one pneumatic port

Furthermore, it can be advantageous if the first adapter and/or the devices of the number of different devices have a locking device with which a device of the number of different devices arranged on the first adapter can be temporarily locked to the adapter.

The locking device can comprise at least one controllable locking means arranged on the first adapter.

The devices of the number of different devices can have a second adapter that corresponds to the first adapter of the tool carrier, wherein the first adapter and the second adapter are designed in such a manner that it is only possible to arrange a device of the number of different devices on the tool carrier in a predetermined position of the second adapter relative to the first adapter.

It can be advantageous if the first adapter and the second adapter can be coupled together in a fluid-tight manner.

The first ports of the first interface device can be coupled or connected to the carrier system using lines arranged on the carrier system, wherein the lines are selected from the group consisting of data lines, power lines, compressed air lines and high-pressure lines.

The devices of the number of different devices may have an identifier that allows the sewer inspection and/or maintenance system to determine which device is located on the tool carrier.

The identifier can be stored in a storage means arranged on or in the devices, wherein the tool carrier has a reading device with which the identifier can be read from the storage means of the device arranged on the tool carrier.

The reading device can be coupled to a control or data processing device of the sewer inspection and/or maintenance system, and the reading device can be designed to transmit the read-out identifier to the control or data processing device.

The first ports of the first interface device can be designed to be controllable, preferably depending on the device arranged on the tool carrier.

In one embodiment of the invention, the lines, in particular the compressed air line and high-pressure line, can be controlled, preferably depending on the device arranged on the tool carrier.

The sewer inspection and/or maintenance system according to any of claims 9 to 14, wherein the tool carrier is arranged on a lifting arm, wherein the lifting arm is arranged on the carrier system.

The lifting arm is preferably designed in such a manner that the tool carrier can be freely positioned in a sewer or pipe with regard to several degrees of freedom.

### BRIEF DESCRIPTION OF THE DRAWINGS

Further details and features of the invention as well as specific, in particular advantageous, embodiments of the invention will be apparent from the following description in conjunction with the drawing. In the figures:

FIG. 1 shows a sewer inspection system known from the state of the art with a lifter on which an inspection camera is mounted;

FIGS. 2A and 2B show a sewer inspection and/or maintenance system according to the invention with a tool carrier and a detailed view of a tool carrier according to the invention;

FIGS. 3A-3D show an adapter of a tool carrier according to the invention in a first embodiment;

FIGS. 4A and 4B show an adapter of a tool carrier according to the invention in a further embodiment;

FIG. 5 shows a sewer inspection and/or maintenance system according to the invention with a device magazine arranged on the carrier system;

FIG. 6 shows a schematic detailed view of a device magazine; and

FIG. 7 shows a block diagram of a sewer inspection and/or maintenance system according to the invention.

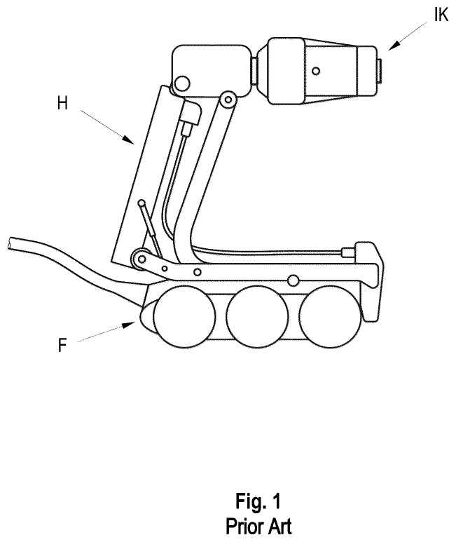

### DETAILED DESCRIPTION OF THE INVENTION

The present invention makes it possible to use a tool carrier to detachably mount various devices on a carrier system, in particular a crawler or a push rod, without the modules or components of the carrier system having to be adapted or replaced. This is made possible by the adapters and interface devices of the tool carrier and the devices. The devices can be devices from different device classes such as tools or inspection units. The tools can include, for example, milling cutters, gripping tools, rinsing nozzles, or the like. The inspection units can include e.g. cameras or other sensor systems.

According to the invention, however, the devices can also comprise devices and systems that remain in the sewer after an inspection or maintenance, such as RFID components, monitoring devices or similar.

The device magazine and the tool carrier make it possible to take various devices into the sewer in different ways. The sewer inspection and/or maintenance system can therefore carry out a device change as needed without having to remove the system from the sewer. The tool carrier can also hold devices and systems that remain in the sewer after an inspection or maintenance—the device magazine is advantageously adapted to also take such devices and systems into the sewer.

“Take into the sewer” means that the carrier system on which the device magazine is arranged can be brought into the sewer together with the devices stored in the device magazine, and can be moved there to the desired location in the sewer.

In one embodiment of the invention, the tool carrier, which has an adapter and an interface device, and the device magazine can be combined so that in a further aspect of the invention, the invention also provides a sewer inspection and/or maintenance system comprising a carrier system, in particular a crawler, and a number of different devices, wherein:
a lifting arm is arranged on the carrier system, at the free end of which a tool carrier is arranged,
the tool carrier has a first adapter,
the lifting arm is designed in such a manner that the tool carrier arranged thereon can be moved between a number of device change positions and at least one device insertion position,
a device magazine for the receptacle of the number of devices is arranged on the carrier system, wherein the devices each have a second adapter which corresponds to the first adapter of the tool carrier, wherein the device can be detachably fastened to the tool carrier by means of the first adapter and the second adapter of a device,
the lifting arm with a device mounted on the first adapter is movable into a first device change position, wherein the first adapter is designed to release the device mounted on the first adapter from the first adapter in the first device change position, and
the lifting arm can be moved into a second device change position without a device mounted on the first adapter, wherein the first adapter is designed to mount a device held in the device magazine on the first adapter in the second device change position.
the tool carrier has a first interface device and the number of different devices each have a second interface device, wherein the first interface device corresponds to the second interface device,
the first interface device has a number of first ports and the second interface device has a number of second ports, wherein at least one port of the first ports can be coupled to at least one port of the second ports when a device of the number of different devices is mounted on the tool carrier.

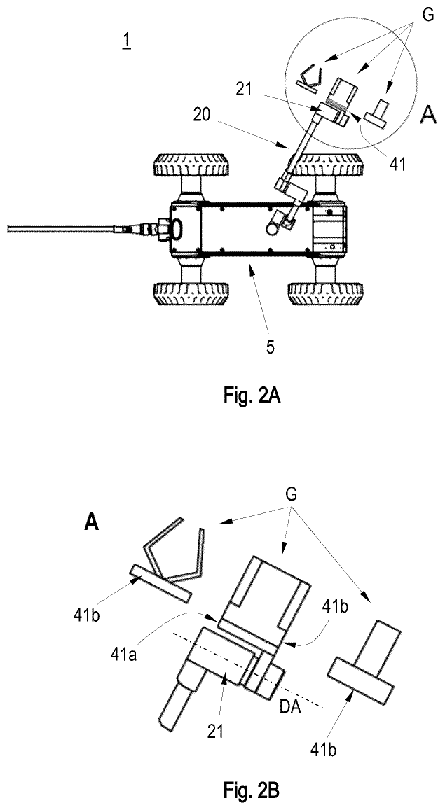

FIGS. 2A and 2B show a sewer inspection and/or maintenance system 1 according to the invention with a tool carrier 21 (FIG. 2A) and a detailed view of a tool carrier according to the invention (FIG. 2B).

The sewer inspection and/or maintenance system 1 comprises a carrier system 5 which is designed here as a crawler. Instead of a crawler, a carrier sled or similar can also be used.

A lifting arm 20 is arranged on the crawler 5, which arm advantageously has a plurality of arm portions coupled to one another in an articulated manner. It is advantageous if the arm portions are movable relative to one another, and the lifting arm 20 as such is movable relative to the crawler 5. It is also advantageous if each arm portion is assigned an adjusting means with which the arm portion can be moved relative to the arm portion to which it is articulated. This allows the free end of the lifting arm 20 to be moved as desired.

At the free end of the lifting arm 20, a tool carrier 21 is arranged which can also be detached from the lifting arm 20 as needed (i.e. optionally), for example for maintenance purposes.

The tool carrier 21 can be designed to be rotatable about a rotation axis DA so that the device arranged on the tool carrier 21 can be pivoted about this axis DA if required.

According to the invention, it is provided that different devices G can be arranged on the tool carrier 21, in particular detachably arranged. For this purpose, an adapter system 41 is provided, which substantially comprises a first adapter 41a and a second adapter 41b, wherein the first adapter 41a is associated with the tool carrier 21, and the second adapter 41b is associated with the device G.

The two adapters, i.e. the adapter 21a of the tool carrier 21 and the adapter 21b of the device, are designed in such a manner that they correspond to one another and the device can preferably be temporarily locked to the tool carrier. For this purpose, the adapter system 41 can comprise a locking device (not shown here). It is advantageous if the locking device comprises at least one controllable locking means arranged on the first adapter, i.e. on the adapter 41a of the tool carrier. The locking device can thus be coupled to a control device of the crawler (carrier system), which can then control and monitor the locking process.

The locking means can comprise, for example, a radially extending pin which, when locked, can be brought into engagement with a blind hole present on the adapter 41b of the device and extending radially there. According to another example, the locking means can also comprise a type of clamping device into which the adapter of the device can be clamped. In principle, any type of locking device can be used as long as it is suitable for locking the device with the adapter of the device to the adapter of the tool carrier.

In order to prevent an incorrect (out-of-position) receptacle of a device by the tool carrier, it has proven to be advantageous if the two adapters 21a and 21b are designed in such a manner that an arrangement of a device on the tool carrier is only possible in a predetermined position of the adapter 41b of the device relative to the adapter 41a tool carrier. This can be achieved, for example, by the geometry of the two adapters, or by positioning pins on the adapter of the tool carrier (or on the adapter of the device), which can be brought into engagement in positioning holes on the adapter of the device (or on the adapter of the tool carrier)—naturally, the positioning pins and positioning holes are arranged in such a manner that they can only be brought together in a predetermined position of the two adapters relative to one another.

The adapter system can be designed such that the adapter 41a of the tool carrier and the adapter 41b of the device can be coupled to one another fluid-tight (gas- and liquid-tight). This can prevent dirt, liquids or gases from penetrating into the intermediate area of the adapter system during a sewer inspection or sewer maintenance.

FIG. 2A shows an example of three devices G that can be arranged on the tool carrier 21 by means of the two adapters 21a and 21b. Due to the interface device designed according to the invention, which is described below, devices of different device classes (sensor systems, cameras, normal tools, fluid-carrying tools such as rinsing nozzles, and the like) can be detachably attached to the tool carrier.

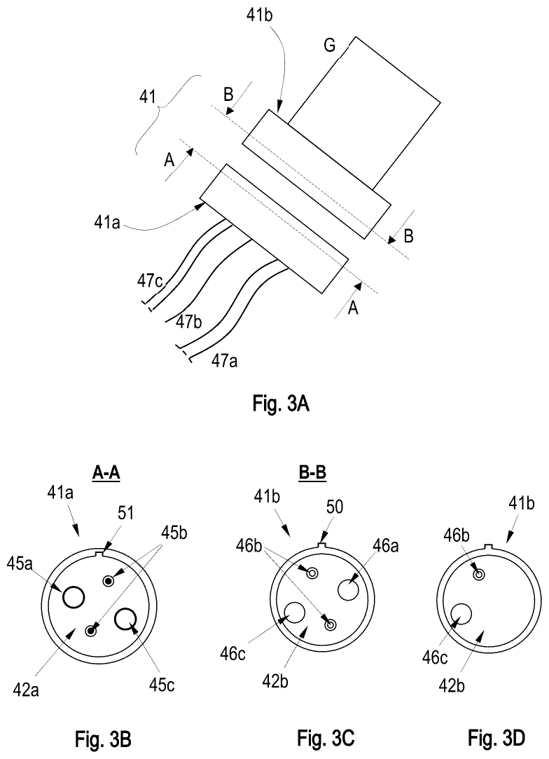

FIGS. 3A-3D show an adapter system 41 of a tool carrier according to the invention according to a first embodiment. FIG. 3A schematically shows the adapter system 41, FIG. 3B shows a section of the first adapter 41a along the sectional axis A-A, FIG. 3C shows a section of the second adapter 41b along the sectional axis B-B, and FIG. 3D shows an alternative embodiment of the second adapter.

The adapter system 41 comprises an adapter 41a associated with the tool carrier and an adapter 41b associated with the device G, wherein the tool carrier is not shown in FIGS. 3A-3D. “Assigned to the tool carrier” or “assigned to the device” means that the tool carrier/device has the adapter in question, or the adapter in question is an integral part of the tool carrier/device.

In the adapter system shown in FIGS. 3A-3D, the adapters 41a and 41b each have a largely round cross section, wherein the adapter 21b of the device can be brought into engagement with the adapter 21a of the tool carrier. The outer diameter of the adapter 21b here substantially corresponds to the inner diameter of the adapter 21a. Of course, a reverse configuration with corresponding diameters is also possible—i.e. the adapter 41a engages in the adapter 41b.

The two adapters 41a, 41b have positioning means which ensure that the two adapters can only be brought into engagement in a particular position relative to each other. For this purpose, the second adapter 41b has a radially outwardly projecting positioning pin 50, which engages in a corresponding recess 51 on the first adapter 41a when the two adapters 41a, 41b are brought together. Of course, other positioning means are also possible which ensure that the two adapters can only be brought together in a certain way. Another type of positioning means is the geometry of the adapters—for example, the outer circumference of the second adapter and the inner circumference of the first adapter may have a polygonal shape in which the two adapters can only be joined at a certain position relative to one another.

According to the invention, the tool carrier has a first interface device 42a and the devices G each has a second interface device 42b. Both interface devices 42a, 42b are designed such that they correspond with each other. For this purpose, the first interface device 42a has a number of first ports 45a; 45b; 45c and the second interface device 42b has a number of second ports 46a; 46b; 46c, wherein at least one port of the first ports 45a; 45b; 45c can be coupled to at least one port of the second ports 46a; 46b; 46c when a device is mounted on the tool carrier (by means of the adapters 41a, 41b). This means that the two interface devices 42a, 42b can also have a different number of connections as long as a connection of the first interface device 42a can be coupled to a connection of the second interface device 42b when a device is attached to the tool carrier.

FIG. 3B shows a first adapter 41a of a tool carrier and FIG. 3C shows a second adapter 41b of a device. These two adapters or the two interface devices 42a and 4b each have four ports 45a; 45b; 45c and 46a; 46b; 46c, wherein the ports 45b and 46b are duplicated here. The ports of the first interface devices 42a are each couplable to a port of the second interface devices 42b, so for example port 45a is couplable to port 46a, port 45b is couplable to port 46b and port 45c is couplable to port 46c.

FIG. 3D shows an alternative configuration of the interface devices 42b of the second adapter 41b. These interface devices 42b according to FIG. 3D can nevertheless be coupled to the interface devices 42a according to FIG. 3B since the connection 46b can be coupled to the connection 45b, and the connection 46c can be coupled to the connection 45c.

The connections 45b can be connections for the transmission of electrical energy and/or connections for the transmission of data. These two connections are designed in the manner of a plug system so that the connection 45b engages in the connection 46b in order to thus establish an electrical contact between the two connections. Alternatively, the connections for transmitting electrical energy and/or for transmitting data can also be designed as contactless connections if, for example, the electrical energy/data is transmitted on an inductive or capacitive basis.

The connections 45a, 46a can be hydraulic connections which can be used, for example, to supply a fluid, e.g. water, to a device G designed as a cleaning nozzle. The hydraulic connections are preferably designed such that they can be coupled pressure- and fluid-tight.

The ports 45c, 46c may be pneumatic ports that can be used, for example, to supply a gas, such as air, to a device G. For example, the gas supplied to the device can be used to pneumatically operate an actuator on the device. The pneumatic connections are preferably designed so that they can be coupled pressure-tight.

If the adapter 41b according to FIG. 3D is coupled to the adapter 41a according to FIG. 3B, then the ports 46b and 46c of the interface device 42b are coupled to the corresponding ports 45b and 45c of the interface device 42a, respectively. The connections 45a and the other of the two connections 45b are not required for the device used. In this case, it can be advantageous to provide a shut-off device, for example in the form of a valve, at least for the connection 45a.

The connections are each coupled to corresponding lines or supply lines 47a, 47b, 47c. For example, the connections 45a (hydraulic connection) and 45c (pneumatic connection) can each be coupled to a high-pressure hose. The connections 45b can be coupled to data and/or power lines.

If, in the case of an adapter 41b as shown in FIG. 3D, the connection 45a of the adapter 41a as shown in FIG. 3B is not required, the above shut-off device can also be provided in the corresponding supply line.

A device designed as a camera can, for example, have an air nozzle with which a kind of air curtain is formed in front of the camera lens that prevents dust or other particles from reaching the lens when the camera is in operation. The interface device 42b of such a camera can have a data connection, a power connection, and a pneumatic connection. Nevertheless, this interface device 42b can be coupled to the interface device 42a shown in FIG. 3B (the hydraulic connection 45a is present but is not required).

The interface device 42b of a device designed as a rinsing nozzle with a camera can have a data connection, a power connection, and a hydraulic connection. However, this interface device 42b can be coupled to the interface device 42a shown in FIG. 3B (the pneumatic connection 45c is present but is not required).

In another example, a camera without any additional functions is used as the device. In this case, the interface device 42b can have a data connection and a power connection. Nevertheless, this interface device 42b can be coupled to the interface device 42a shown in FIG. 3B (the pneumatic connection 45c and the hydraulic connection 45a are present but are not required).

In the same way, a rinse head without any other function can be used as a device. In this case, it is sufficient if the interface device 42b has only one hydraulic connection. Nevertheless, this interface device 42b can be coupled to the interface device 42a shown in FIG. 3B (the pneumatic connection 45c and the two connections 45b are present but not required).

In one embodiment of the invention, the devices can each have an identifier that enables the sewer inspection and/or maintenance system to determine which device is currently arranged on the tool carrier.

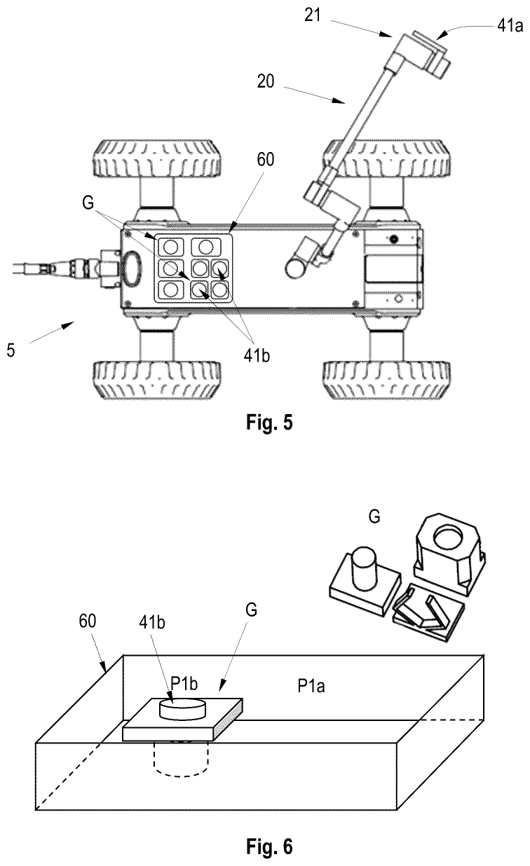

The identifier can be stored in a storage means arranged on or in the device, and the tool carrier or the adapter of the tool carrier can have a reading device with which the identifier can be read from the storage means of the device arranged on the tool carrier. The storage means can be an RFID tag that can be read with a reading device designed as an RFID reader. Alternatively, the storage means can also be a barcode or QR code (which stores the identifier in coded form) that can be read with a reading device designed as a barcode or QR code reader. When using a device magazine as described below with reference to FIG. 5, such an identifier can also be omitted if it is known which device is located where in the device magazine. However, the use of an identifier is advantageous when a device is manually attached to the tool carrier. In this case, the system can automatically determine which device is on the tool carrier.

If it is known which device is located on the tool carrier, a control device of the system, such as a control device on the crawler or a control device located outside the sewer, can automatically deactivate the lines/supply lines that are not required. For this purpose, the control device can be adapted in such a way that it prevents an operator from inadvertently activating an unnecessary supply line.

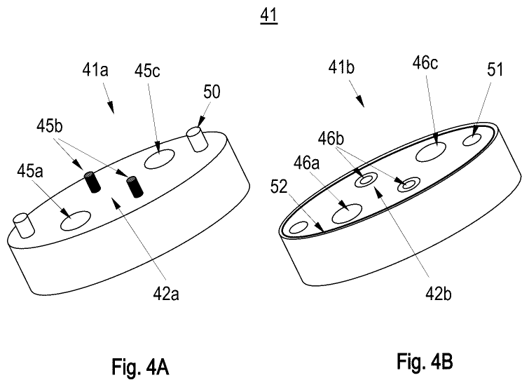

FIGS. 4A and 4B show an adapter system 41 of a tool carrier according to the invention according to a further embodiment. FIG. 4A schematically shows a first adapter 41a of the tool carrier, and FIG. 4B schematically shows a second adapter 41b of the device.

In contrast to the adapter system shown in FIGS. 3A-3D, in this case the two adapters 41a and 41b do not mesh with each other. For this reason, it may be advantageous to provide a circumferential sealing ring on the adapter 41a and/or the adapter 41b.

The function and mode of operation of the two interfaces 42a and 42b corresponds to the function and mode of operation of the two interfaces described with reference to FIGS. 3A-3D.

In contrast to the adapter system described in FIGS. 3A-3D, in this case two axially protruding positioning pins 50 are arranged on the first adapter 41a, which engage in corresponding recesses 51 in the second adapter 41b.

The adapter system shown in FIGS. 4A and 4B also provides locking means (not shown here) to lock the first adapter to the second adapter.

The tool carrier and the adapter system described above, including the interface system, can be used advantageously to attach different devices, for example to a lifting arm, without having to adapt the lifting arm for this purpose. However, they are particularly advantageous when the devices have to be replaced during operation, i.e. when the inspection and/or maintenance system is in the sewer. This is now possible without having to remove the inspection and/or maintenance system from the sewer.

According to a further aspect of the invention, the carrier system such as a crawler has a device magazine for accommodating a number of devices.

A carrier system 5 with a device magazine arranged thereon is shown in FIG. 5, a schematic view of a device magazine is shown in FIG. 6.

The carrier system 5, which is designed as a crawler here, has a lifting arm 20, at the free end of which a tool carrier 21 is arranged, as described above. The tool carrier 21 has a first adapter 41a, which corresponds to the first adapter described above. A number of devices G are arranged in the device magazine 60, with seven devices being located in the device magazine 60 in FIG. 5. The devices each have a second adapter 41b which corresponds to the second adapters described above.

By means of the first adapter 41a and the second adapter 41b, a device can be detachably fastened to the tool carrier 21, wherein it is possible according to the invention for the device that is to be fastened to be arranged in the device magazine 60.

In order to pick up a device from the device magazine 60 with the tool carrier 21 arranged on the lifting arm, it is provided according to the invention that the lifting arm 20 is designed in such a manner that the tool carrier 21 arranged thereon can be moved between a number of device change positions P1 and at least one device insertion position P2. With n devices in the device magazine 60, the tool carrier 21 can therefore occupy n device change positions P1.

When changing the device, the lifting arm 20 with a device attached to the first adapter 41a is moved into a first device changing position P1a, wherein the first adapter 41a is designed to release the device attached to the first adapter 41a from the first adapter 41a in the first device changing position P1a, i.e. to place the device in the device magazine. The first device changing position P1a in this case corresponds to a position in or on the device magazine at which the device is placed in the magazine.

Subsequently, the lifting arm 20 is moved to a second device change position P1b without a device mounted on the first adapter 41a, wherein the first adapter 41a is configured to mount a device G received in the device magazine 60 on the first adapter 41a in the second device change position P1b. The second device changing position P1b in this case corresponds to a position in or on the device magazine at which the device to be picked up is located in the magazine.

As described above, the first adapter 41a and the second adapter 41b have a locking device (not shown here) with which a device G arranged on the first adapter 41a or picked up from the device magazine can be temporarily locked on the first adapter.

The locking device can comprise at least one controllable locking means arranged on the first adapter 41a, wherein the locking means is movable with respect to the tool carrier 21 between a locked position and an unlocked position. When a device is placed in the device magazine, the locking means is moved from the locked position to the unlocked position, and thus the device attached to the adapter 41a is released from the adapter 41a. To pick up, or when picking up, a device from the device magazine, the locking device is in the unlocked position. After the device has been arranged on the first adapter 41a, the locking means is moved from the unlocked position to the locked position. The device is now firmly connected to the tool carrier. The locking device can correspond to the locking device described above with reference to FIGS. 2A and 2B.

In one embodiment of the invention, it can be provided that the locking means is moved from the locked position to the unlocked position when the lifting arm or the tool carrier is not in a device changing position. As explained above, the device can be a device that remains in the sewer after an inspection or after maintenance, such as monitoring units or the like. Such devices can also be accommodated in the device magazine and advantageously have a second adapter, as described above. With the aid of the tool carrier 21 according to the invention, such devices can be removed from the device magazine and placed at a predetermined location in the sewer. Such devices are also subsequently referred to as “lost” devices.

It can be advantageous if lost devices also have a unique identifier or have a storage means in which a unique identifier of the device is stored. In an advantageous embodiment, the storage means is a writable storage means, such as an RFID tag. The identifier can be read from the storage means using a reading device arranged on the tool carrier or on the adapter of the tool carrier. In one embodiment of the invention, in addition to the reading device, a writing device can also be provided on the tool carrier or on the adapter of the tool carrier (or alternatively a writing/reading device) with which information can be written to the storage means. For example, when a lost device is placed in the sewer, the system can write the position of the lost device in the sewer to the storage means.

It is advantageous if, in the device magazine, a predetermined position within the device magazine is provided for each device accommodated therein. A control device with which the lifting arm is controlled can thus move or control the lifting arm independently (i.e. without human intervention) to the corresponding device changing position and can pick up the device placed there. An operator thus only has to indicate at an input device which device is to be picked up with the tool carrier. The control device then automatically causes the device attached to the tool carrier to be placed in the device magazine (if a device is attached to the tool carrier) and automatically picks up the desired device from the device magazine.

Since a predetermined position in the device magazine is also provided for the device to be placed in the device magazine, the control device can also move or control the lifting arm to the corresponding device changing position.

The above-mentioned identifier can be used to ensure that the control device always knows which device is currently arranged on the tool carrier. If devices are only taken from the device magazine, the control device knows which device is currently on the tool carrier even without such an identifier.

The picking up and placing of devices from or into the device magazine can thus be completely automated.

The device magazine 60 optionally has a securing device (not shown here) for a device G accommodated therein, with which the device can be releasably locked in the device magazine 60 after being accommodated in the device magazine 60. The safety device ensures that the device does not fall out of the device magazine during operation of the sewer inspection and/or maintenance device, which could be the case due to vibrations of the crawler, for example. The securing device can for example be a magnet. The securing device can however also include grippers or locking devices.

In an advantageous embodiment of the invention, the securing device can be designed as a controllable securing device. Advantageously, it can be controlled in such a manner that a locking mechanism of a device to be removed from the device magazine 60 with the lifting arm 20 is only released when the device is mounted on the first adapter 41a. Whether the device is attached to the first adapter can be determined by means of the locking device associated with the first adapter (for locking a device to the first adapter), in particular if it is a controllable locking in device.

Furthermore, it is advantageous if the securing device can be controlled in such a way that a device to be placed in the device magazine 60 is locked before the device is released from the first adapter 41a. For this purpose, the control device of the crawler can be designed such that the device is not released from the first adapter 41a until the device is locked in the device magazine 60.

In both cases, this ensures that a device is at no time in an unsecured state.

The lifting arm 20 is designed such that the tool carrier 21 can be freely positioned in a sewer or pipe with regard to a plurality of degrees of freedom, i.e. can be moved in all directions. It can also be advantageous if the tool carrier itself is arranged so that it can rotate and/or pivot on the lifting arm.

A combination of the device magazine according to the invention with a tool carrier according to the invention and the corresponding adapters of the tool carrier and the devices enables a particularly efficient sewer inspection and/or maintenance. All required devices (e.g. inspection camera, rinsing nozzle, milling cutter, lost devices, etc.) can be carried in the device magazine. With the tool carrier, the particular required device can be picked up from the device magazine and moved to any position using the lifting arm mentioned above.

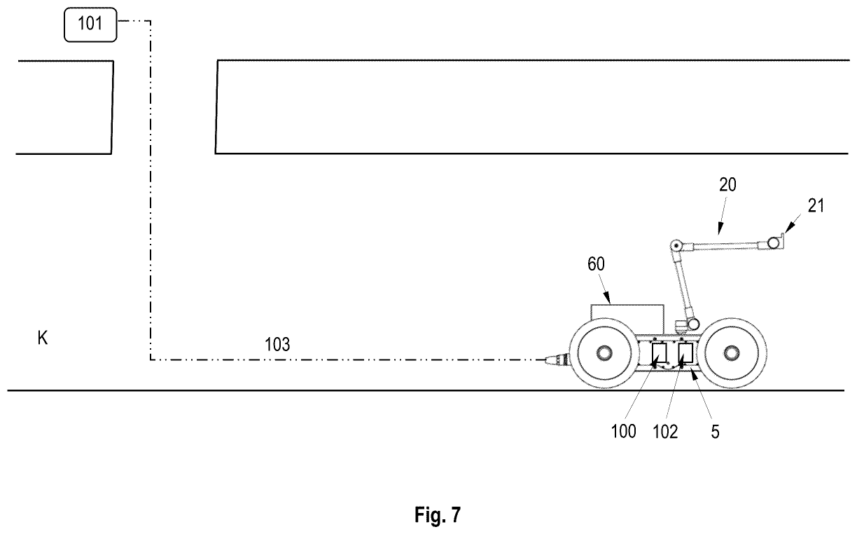

FIG. 7 shows a block diagram of a sewer inspection and/or maintenance system according to the invention.

An inspection and/or maintenance device of an inspection and/or maintenance system is arranged in a sewer K, which can be moved in the sewer. The inspection and/or maintenance device has a crawler 5 as a carrier system on which an articulated lifting arm 20 is arranged. The lifting arm in this case has two lifting arm segments which are coupled to one another in an articulated manner, wherein the two lifting arm segments can be moved relative to one another by an actuator. At the free end of the lifting arm, a tool carrier 21 is arranged which, as described above, has a first adapter which in turn has controllable locking means for locking an accommodated device. The other end of the lifting arm is pivotably and/or rotatably connected to the crawler, appropriate adjustment means being provided for the pivoting/rotating. The crawler can have a drive controller 102 with which the drive units of the crawler wheels can be controlled.

The inspection and/or maintenance system here also has an operating unit 101 which is coupled to a control device 100 of the inspection and/or maintenance device via a communication connection 103. The communication connection 103 can be wired or wireless.

For its part, the control device 100 is coupled or connected to the drive control 102, to the device magazine 60, to the actuating means of the lifting arm 20 or the lifting arm segments and to the tool carrier 21. The adapter or the controllable locking means of the adapter can be controlled by means of the control device 100. The changing of a device described above can also be carried out by means of the control device 100. Furthermore, the securing device of the tool carrier can also be controlled by means of the control device 100, as also described above.

The control device 100 is shown here as part of the inspection and/or maintenance device. In an alternative embodiment of the invention, the control device 100 can also be part of the operating unit, or the function of the control device 100 can be taken over by the operating unit.

We claim:

1. A tool carrier for sewer inspection and/or maintenance systems for mounting various devices on a carrier system, in particular a carriage or push rod of the sewer inspection and/or maintenance system, wherein the tool carrier
is or can be arranged on the carrier system,
has an adapter designed for removably attaching the devices to the tool carrier, and
has a first interface device that corresponds to a second interface device of the device, wherein the first interface device has a number of first ports, wherein at least one port of the first ports can be coupled to at least one port of a number of second ports of the second interface device, whereby the devices can be attached to the tool carrier in an interchangeable manner.

2. The tool carrier according to claim 1, wherein the first ports and the second ports comprise
at least one port for data transmission, and/or
at least one port for transmitting electrical energy, and/or
at least one hydraulic port, and/or
at least one pneumatic port.

3. A sewer inspection and/or maintenance system comprising a carrier system, in particular a crawler or push rod, and a number of different devices, wherein
a tool carrier is arranged on the carrier system,
the tool carrier has a first adapter for removably arranging a device of the number of different devices on the tool carrier,
the tool carrier has a first interface device and the number of different devices each have a second interface device, wherein the first interface device corresponds to the second interface device,
the first interface device has a number of first ports and the second interface device has a number of second ports, wherein at least one port of the first ports can be coupled to at least one port of the second ports when a device of the number of different devices is mounted on the tool carrier.

4. The sewer inspection and/or maintenance system according to claim 3, wherein the first ports and the second ports comprise
at least one port for data transmission, and/or
at least one port for transmitting electrical energy, and/or
at least one hydraulic port, and/or
at least one pneumatic port.

5. The sewer inspection and/or maintenance system according to claim 3, wherein the first adapter and/or the devices of the number of different devices have a locking device with which a device of the number of different devices arranged on the first adapter can be temporarily locked to the adapter.

6. The sewer inspection and/or maintenance system according to claim 5, wherein the locking device comprises at least one controllable locking means arranged on the first adapter.

7. The sewer inspection and/or maintenance system according to claim 3, wherein the devices of the number of different devices have a second adapter that corresponds to the first adapter of the tool carrier, wherein the first adapter and the second adapter are designed in such a manner that a device of the number of different devices can be arranged on the tool carrier only in a predetermined position of the second adapter relative to the first adapter.

8. The sewer inspection and/or maintenance system according to claim 7, wherein the first adapter and the second adapter are couplable to one another in a fluid-tight manner.

9. The sewer inspection and/or maintenance system according to claim 3, wherein the first ports of the first interface device are coupled or can be coupled on the carrier system side to lines arranged on the carrier system, wherein the lines are selected from the group consisting of data lines, power lines, compressed air lines and high-pressure lines.

10. The sewer inspection and/or maintenance system according to claim 3, wherein the devices of the number of different devices have an identifier that enables the sewer inspection and/or maintenance system to determine which device is arranged on the tool carrier.

11. The sewer inspection and/or maintenance system according to claim 10, wherein the identifier is stored in a storage means arranged on or in the devices, wherein the tool carrier has a reading device with which the identifier can be read out of the storage means of the device arranged on the tool carrier.

12. The sewer inspection and/or maintenance system according to claim 11, wherein the reading device is coupled to a control or data processing device of the sewer inspection and/or maintenance system, and the reading device is designed to transmit the read identifier to the control or data processing device.

13. The sewer inspection and/or maintenance system according to claim 3, wherein the first ports of the first interface device are designed to be controllable, preferably in dependence on the device arranged on the tool carrier.

14. The sewer inspection and/or maintenance system according to claim 9, wherein the lines, in particular the compressed air line and high pressure line, are controllable, preferably in dependence on the device arranged on the tool carrier.

15. The sewer inspection and/or maintenance system according to claim 9, wherein the tool carrier is arranged on a lifting arm, wherein the lifting arm is arranged on the carrier system.

16. The sewer inspection and/or maintenance system according to claim 15, wherein the lifting arm is designed in such a manner that the tool carrier can be freely positioned in a sewer or pipe with respect to several degrees of freedom.
